(19) United States
(12) Patent Application Publication
(10) Pub. No.: US 2007/0120081 A1
(43) Pub. Date: May 31, 2007

(54) Solenoid valve for different air discharging speeds

(75) Inventor: T. C. Huang, Changhua County (TW)

Correspondence Address: BACON & THOMAS, PLLC, 625 SLATERS LANE, FOURTH FLOOR, ALEXANDRIA, VA, 22314, US

(73) Assignee: TRICORE CORPORATION, CHANG HUA (TW)

(21) Appl. No.: 11/604,864

(22) Filed: Nov. 28, 2006

(30) Foreign Application Priority Data
Nov. 30, 2005 (TW) 94220832

(51) Int. Cl. F16K 51/00

(52) U.S. Cl. 251/117

(57) ABSTRACT

A solenoid valve includes a holder, which holds a locating rod that defines an air discharging hole for quick discharge of an air, a coil assembly, an actuating rod axially slidably mounted in the coil assembly, a spring stopped between the actuating rod and the locating rod, a flexible seal for sealing the air discharging hole and the coil assembly is energized to move the actuating rod toward the locating rod, and a slow-speed air discharging hole, which may be formed in the locating rod, the actuating rod, or the flexible seal for discharging of an air after blocking of the air discharging hole by the seal.

### BACKGROUND OF THE INVENTION

1. Field of the Invention

The present invention relates to solenoid valves and more particularly, to such a solenoid valve that provides different air discharging speeds.

2. Description of the Related Art

Conventional solenoid valves for controlling discharging of an air commonly provide only one quick air discharging action, i.e., only rapid air discharging speed. However, there is still a demand for a slow air discharging speed. Therefore, solenoid valves that provide quick and slow air discharging speeds are developed.

However, conventional dual-speed solenoid valves or low-speed solenoid valves commonly have a complicated structure. These complicated solenoid valves may not work accurately during operation. Further, these complicated solenoid valves are difficult to install and, not durable in use.

Therefore, it is desirable to provide a solenoid valve that eliminates the aforesaid drawbacks.

### SUMMARY OF THE INVENTION

The present invention has been accomplished under the circumstances in view. It is one object of the present invention to provide a simple structure of solenoid valve, which provides a quick air discharging speed and a slow air discharging speed.

It is another object of the present invention to provide a simple structure of solenoid valve, which works accurately and positive.

It is still another object of the present invention to provide a simple structure of solenoid valve, which is easy to install and durable in use.

To achieve these and other objects of the present invention, the solenoid valve comprises a holder, the holder comprising a yoke frame, a receiving space defined in the yoke frame, a locating rod fixedly mounted in a side panel of the yoke frame, and an air discharging hole axially extending through two distal ends of the locating rod; a coil assembly, the coil assembly comprising a bobbin, the bobbin defining therein an axially extending sliding hole, and a coil wound round the bobbin; an actuating rod, the actuating rod comprising a rod body axially slidably mounted in the axially extending sliding hole of the bobbin; spring means stopped between the actuating rod and the locating rod; and seal means, the seal means comprising a flexible stopper adapted to seal the air discharging hole when the coil assembly is energized to move the actuating rod toward the locating rod; and a slow-speed air discharging hole for discharging of an air after blocking of the air discharging hole by the seal means. The slow-speed air discharging hole may be formed in the locating rod, the actuating rod, or the seal means.

### BRIEF DESCRIPTION OF THE DRAWINGS

FIG. 1 is an exploded view of a solenoid valve according to the present invention.

FIG. 2 is a sectional side plain view of FIG. 1.

FIG. 3 is a sectional top assembly view taken of the solenoid valve shown in FIG. 1.

FIG. 4 is a sectional view taken along line 4-4 of FIG. 3.

FIG. 5 is similar to FIG. 4 but showing the closed status of the solenoid valve.

FIG. 6 is a sectional assembly view of a part of an alternate form of the solenoid valve according to the present invention.

FIG. 7 is a sectional assembly view of a part of another alternate form of the solenoid valve according to the present invention.

FIG. 8 is a sectional assembly view of a part of still another alternate form of the solenoid valve according to the present invention.

FIG. 9 is a sectional assembly view of a part of still another alternate form of the solenoid valve according to the present invention.

FIG. 10 is a sectional assembly view of a part of still another alternate form of the solenoid valve according to the present invention.

FIG. 11 is a sectional assembly view of a part of still another alternate form of the solenoid valve according to the present invention.

### DETAILED DESCRIPTION OF THE INVENTION

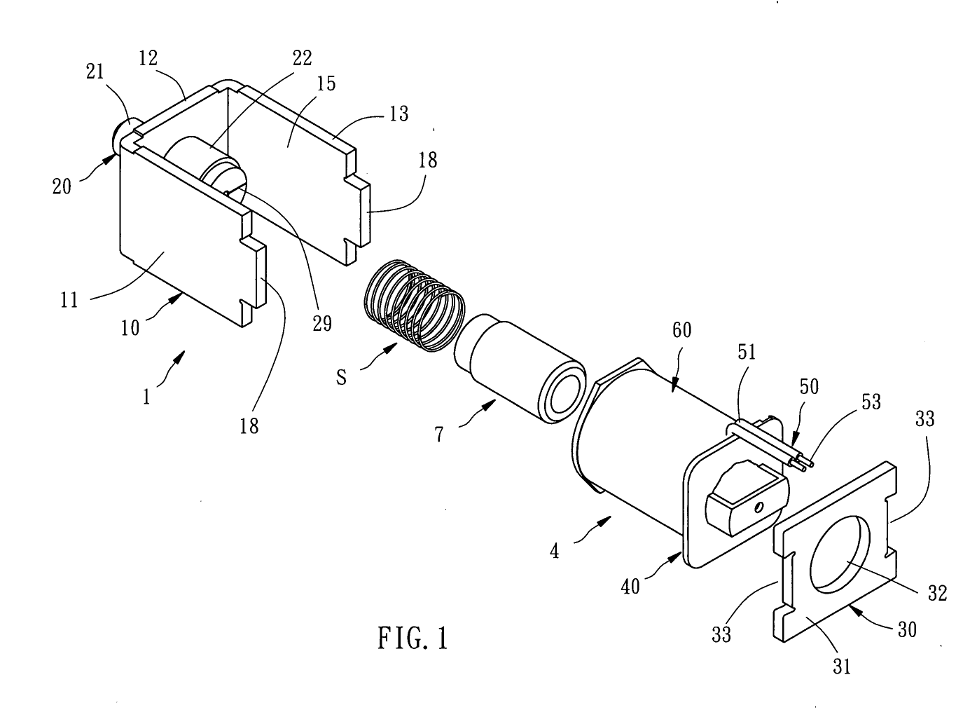

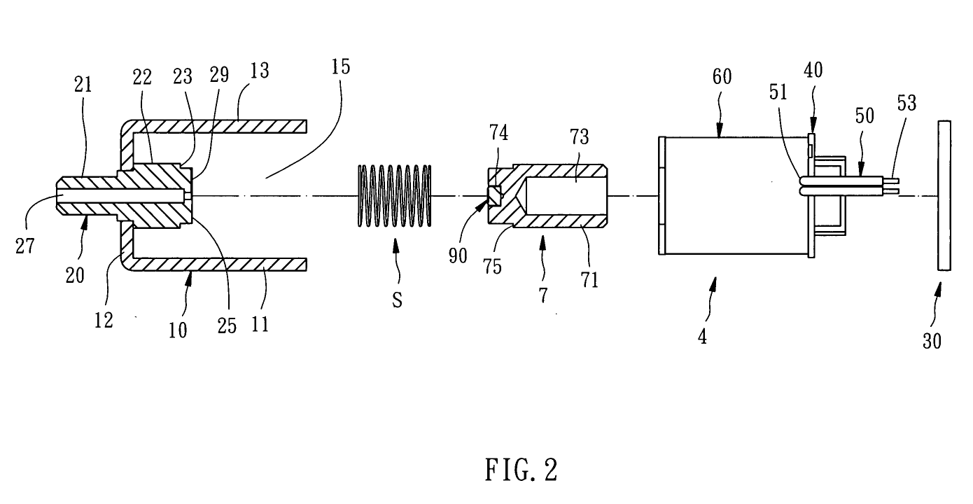

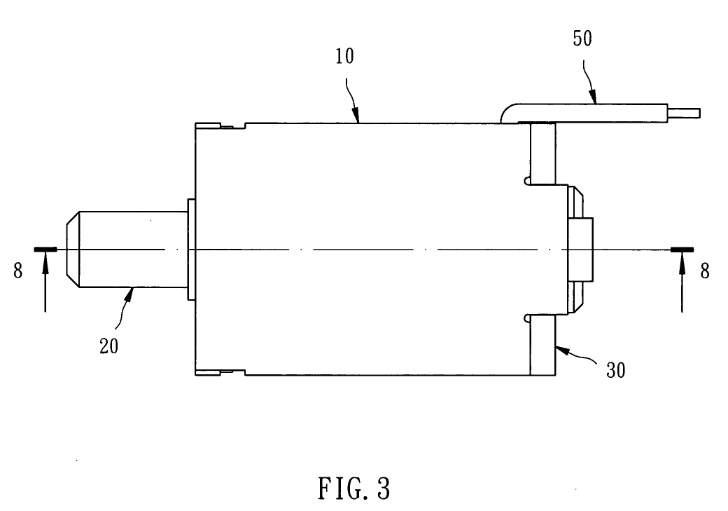

Referring to FIGS. 1˜5, a solenoid valve in accordance with one embodiment of the present invention is shown controllable to reciprocate. The solenoid valve comprises a holder 1, a coil assembly 4, an actuating rod 7, a seal 90, and a spring member S.

The holder 1 is comprised of a yoke frame 10, a locating rod 20, and a cover plate 30. The yoke frame 10 is a metal frame having a bottom panel 11, a top panel 13, and a side panel 12 connected between the bottom panel 11 and the top panel 13 at one side. The bottom panel 11, the top panel 13 and the side panel 12 surround a receiving space 15. Further, the bottom panel 11 and the top panel 13 each have a protruding locating block 18. The locating rod 20 is mounted in the side panel 12 of the yoke frame 10, having a first rod section 21 disposed outside the yoke frame 11, a second rod section 22 connected to one end of the first rod section 21, a bearing portion 23 for supporting the spring member S, a stop edge 25 at one end of the bearing portion 23, an axial through hole 27 axially extending through the two distal ends thereof, and an air discharging hole 29, which is a groove transversely running over the stop edge 25. The cover plate 30 has a body 31, a center opening 32 cut through the center of the body 31, and two mounting notches 33 disposed on two opposite lateral sides of the body 31 and respectively coupled to the locating blocks 18.

The coil assembly 4 comprises a bobbin 40, a coil 50, and an electrically insulative film 60. The bobbin 40 has a hollow cylindrical body 41 defining a sliding hole 45. The coil 50 is formed of a copper wire 51 and wound round the hollow cylindrical body 41 of the bobbin 40, having two lead-out ends 53. The electrically insulative film 60 is wrapped about the coil 50.

The actuating rod 7 is formed of a barrel-like shank 70, which has a body 71 axially slidably mounted in the sliding hole 45 inside coil assembly 4, a first mounting hole 73 axially backwardly extending to the rear side of the body 71, a second mounting hole 74 formed in the front side of the body 71, and bearing portion 75 provided around the periphery of the body 71 for bearing the spring member S. Further a magnet (not shown) is fixedly mounted in the first mounting hole 73 inside the actuating rod 7.

The seal 90 is formed of a rubber stopper having a stopper body 91 fixedly fastened to the second mounting hole 74 of the actuating rod 7 and an annular protrusion 93 protruded from the front side of the stopper body 91 for stopping against the stop edge 25 of the locating rod 20.

The spring member S is a compression spring supported between the bearing portion 23 of the locating rod 20 and the bearing portion 75 of the actuating rod 7.

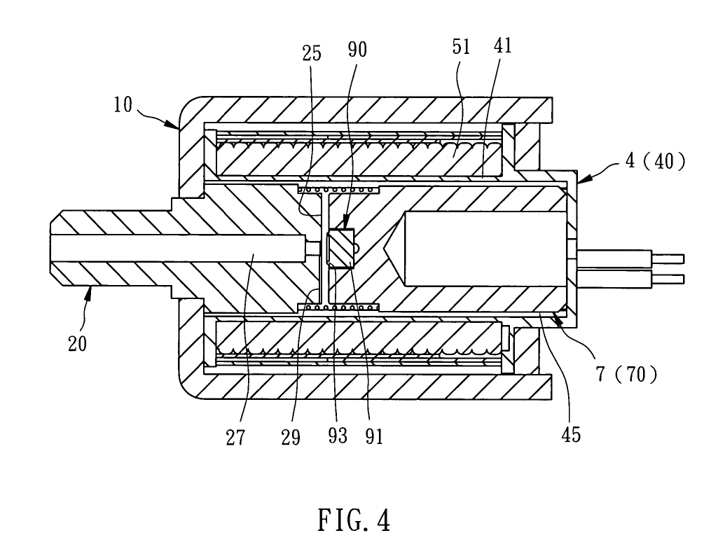

The operation of the solenoid valve is outlined hereinafter. Before connection of electric current to the coil 50, as shown in FIG. 4, the actuating rod 7 does no work, and the spring member S pushes the actuating rod 7 away from the locating rod 20, keeping the annular protrusion 93 of the seal 90 spaced from the stop edge 25 of the locating rod 20 at a distance for quick discharging of the air (not shown) through the axial through hole 27.

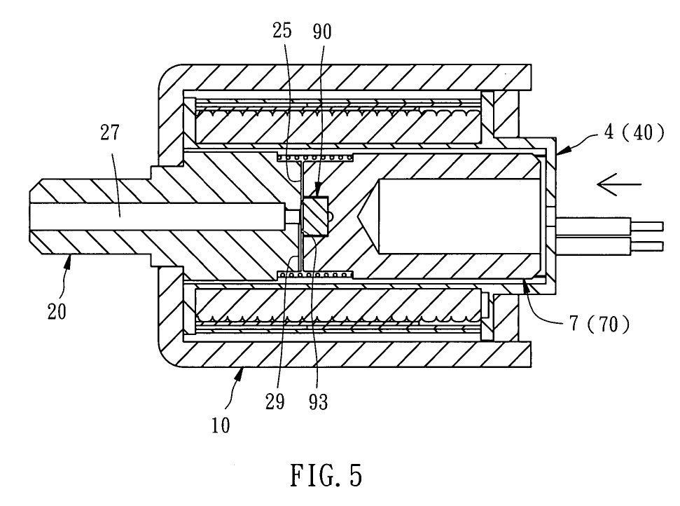

On the contrary, as shown in FIG. 5, when the coil 50 is electrically energized to produce a magnetic force, the actuating rod 7 is forced by the magnetic force to overcome the spring force of the spring member S and to move toward the locating rod 20, thereby stopping the annular protrusion 93 of the seal 90 against the stop edge 25 of the locating rod 20 over one end of the axial through hole 27, for enabling the air to discharging through the air discharging hole 29.

FIG. 6 shows an alternate form of the solenoid valve according to the present invention. According to this embodiment, the air discharging hole 29A is a transverse inside hole perpendicularly extending from the axial through hole of the locating rod to the periphery of the locating rod.

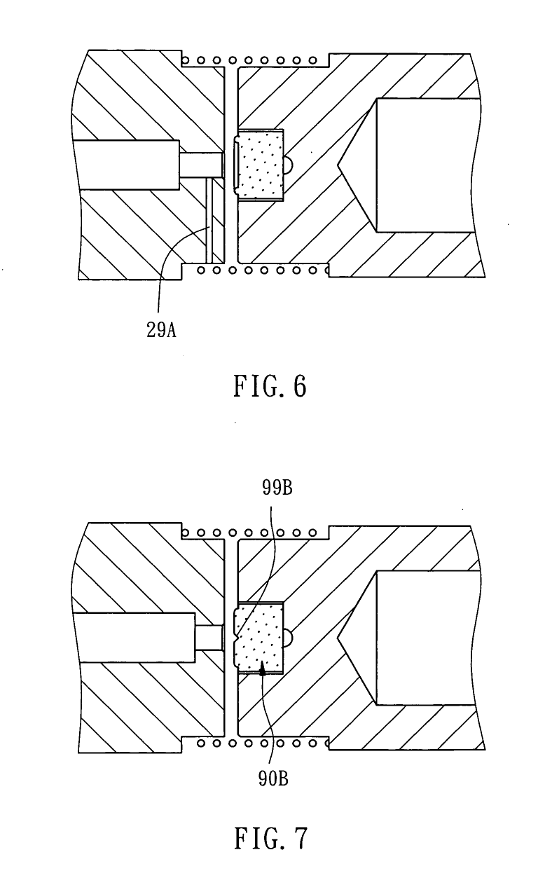

FIG. 7 shows another alternate form of the solenoid valve according to the present invention. According to this embodiment, the seal 90B is fixedly fastened to the actuating rod, having a transversely extending air discharging hole 99B on the front side thereof.

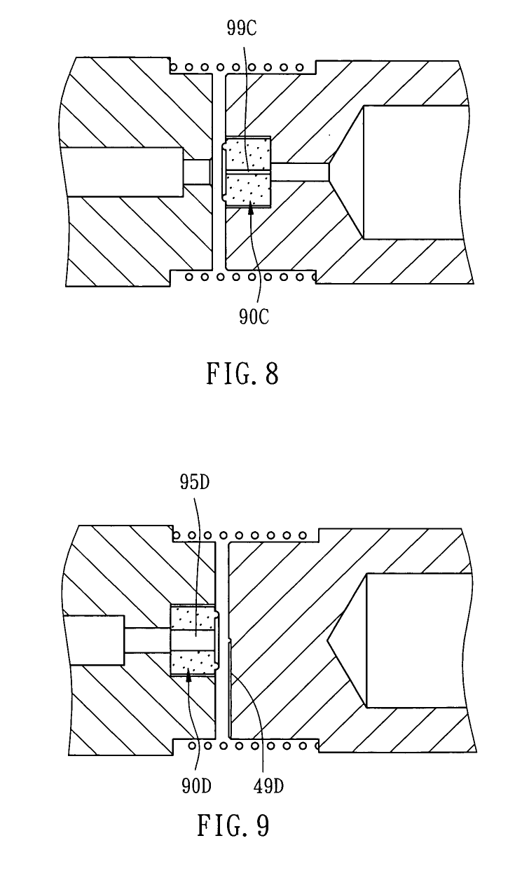

FIG. 8 shows still another alternate form of the solenoid valve according to the present invention. According to this embodiment, the seal 90C is fixedly fastened to the actuating rod, having an air discharging hole 99C axially extending through the front and rear sides thereof.

FIG. 9 shows still another alternate form of the solenoid valve according to the present invention. According to this embodiment, the seal 90D is fixedly mounted in the locating rod and partially protruding over the stop edge of the locating rod, having a through hole 95D. Further, an air discharging groove 49D is formed on the front side of the body of the actuating rod. The air discharging groove 49D is disposed in communication with the through hole 95D when the actuating rod is stopped against the locating rod.

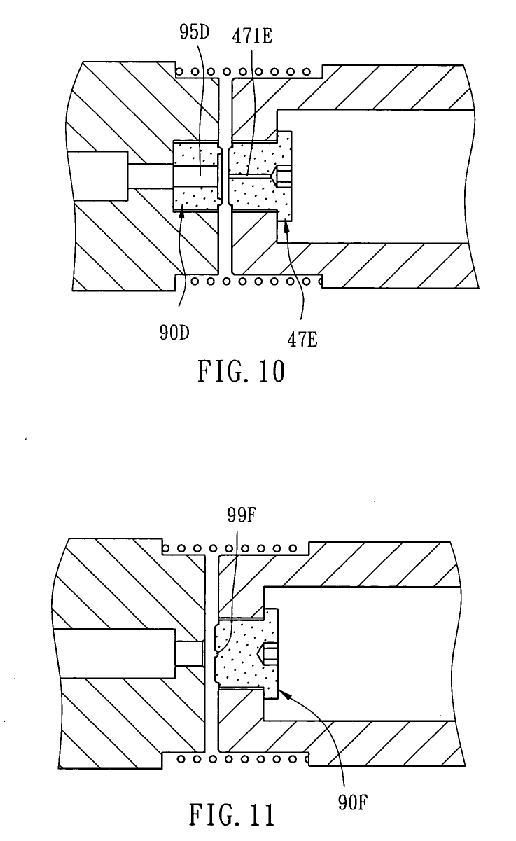

FIG. 10 shows still another alternate form of the solenoid valve according to the present invention. According to this embodiment, the seal 90D is same as the embodiment shown in FIG. 9; an air discharging screw tip 47E is threaded into the second mounting hole of the actuating rod, having an air discharging hole 99F axially extending through the front and rear sides thereof for discharging of the air at a low speed.

FIG. 11 shows still another alternate form of the solenoid valve according to the present invention. According to this embodiment, the seal 90F is threaded into the second mounting hole of the actuating rod, having an air discharging groove 471E transversely formed on the front side thereof for discharging of the air at a low speed.

As indicated above, the invention provides a solenoid valve, which has the benefits as follows:

1. The solenoid valve has a simple structure that provides a quick air discharging speed and a slow air discharging speed.

2. The solenoid valve is easy to install and durable in use, and works accurately and positively.

What is claimed is:

1. A solenoid valve comprising:
a holder, said holder comprising a yoke frame, a receiving space defined in said yoke frame, a locating rod fixedly mounted in a side panel of said yoke frame, an air discharging hole axially extending through two distal ends of said locating rod, and a slow-speed air discharging portion in communication with said air discharging hole;
a coil assembly, said coil assembly comprising a bobbin, said bobbin defining therein an axially extending sliding hole, and a coil wound round said bobbin;
an actuating rod, said actuating rod comprising a rod body axially slidably mounted in said axially extending sliding hole of said bobbin and movable by a magnetic force toward said locating rod when said coil of said coil assembly is electrically energized;
spring means stopped between said actuating rod and said locating rod; and
seal means provided at one end of said rod body of said actuating rod, said seal means comprising a flexible stopper adapted to seal said air discharging hole for enabling an air to pass through said slow-speed air discharging portion.

2. The solenoid valve as claimed in claim 1, wherein said slow-speed air discharging portion is an air discharging groove transversely formed on one end of said locating rod corresponding to said actuating rod.

3. The solenoid valve as claimed in claim 1, wherein said slow-speed air discharging portion is a transverse inside hole formed in said locating rod and perpendicularly extending from said air discharging hole to the periphery of said locating rod.

4. A solenoid valve comprising:
a holder, said holder comprising a yoke frame, a receiving space defined in said yoke frame, a locating rod fixedly mounted in a side panel of said yoke frame, and an air discharging hole axially extending through two distal ends of said locating rod;
a coil assembly, said coil assembly comprising a bobbin, said bobbin defining therein an axially extending sliding hole, and a coil wound round said bobbin;
an actuating rod, said actuating rod comprising a rod body axially slidably mounted in said axially extending sliding hole of said bobbin and movable by a magnetic force toward said locating rod when said coil of said coil assembly is electrically energized;
spring means stopped between said actuating rod and said locating rod; and
seal means provided at one end of said rod body of said actuating rod, said seal means comprising a flexible stopper adapted to seal said air discharging hole, and a slow-speed air discharging portion for discharging of an air at a slow speed after blocking of said air discharging hole by said seal means.

5. The solenoid valve as claimed in claim 4, wherein said slow-speed air discharging portion is an air discharging groove transversely formed on an outer side of said flexible stopper facing said locating rod.

6. The solenoid valve as claimed in claim 4, wherein said slow-speed air discharging portion is an axial through hole cut through front and rear sides of said flexible stopper.

7. The solenoid valve as claimed in claim 4, wherein said flexible stopper of said seal means comprises an annular protrusion protruded from a front side thereof for stopping against said locating rod; said slow-speed air discharging portion is formed on said annular protrusion.

8. A solenoid valve comprising:
a holder, said holder comprising a yoke frame, a receiving space defined in said yoke frame, a locating rod fixedly mounted in a side panel of said yoke frame, and an air discharging hole axially extending through two distal ends of said locating rod;
a coil assembly, said coil assembly comprising a bobbin, said bobbin defining therein an axially extending sliding hole, and a coil wound round said bobbin;
an actuating rod, said actuating rod comprising a rod body axially slidably mounted in said axially extending sliding hole of said bobbin and movable by a magnetic force toward said locating rod when said coil of said coil assembly is electrically energized, and a slow-speed air discharging portion for discharging of an air at a low speed;
spring means stopped between said actuating rod and said locating rod; and
seal means provided at one end of said rod body of said actuating rod, said seal means comprising a flexible stopper adapted to seal said air discharging hole for enabling an air to pass through said slow-speed air discharging portion, said flexible stopper having a through hole in communication with said slow-speed air discharging portion.

9. The solenoid valve as claimed in claim 8, wherein said slow-speed air discharging portion is an air discharging groove transversely formed on one end of said actuating rod.

10. The solenoid valve as claimed in claim 8, wherein said slow-speed air discharging portion is an axial hole axially running in said actuating rod.
